(19) United States
(12) Patent Application Publication
(10) Pub. No.: US 2013/0132705 A1
(43) Pub. Date: May 23, 2013

(54) DE-INTERLEAVING DEVICE, DE-INTERLEAVING METHOD, DATA TRANSMISSION SYSTEM, AND DATA TRANSMISSION METHOD

(71) Applicant: Panasonic Corporation, Osaka (JP)

(72) Inventor: Tatsuji ISHII, Osaka (JP)

(73) Assignee: PANASONIC CORPORATION, Osaka (JP)

(21) Appl. No.: 13/738,691

(22) Filed: Jan. 10, 2013

Related U.S. Application Data
(63) Continuation of application No. PCT/JP2011/000091, filed on Jan. 12, 2011.

(30) Foreign Application Priority Data
Jul. 12, 2010 (JP) 2010-158054

(51) Int. Cl. G06F 12/06

(52) U.S. Cl. CPC G06F 12/0607
USPC 711/211

(57) ABSTRACT

A de-interleaving device for de-interleaving an input data block interleaved by storing data of an original data block including R×C′ portions (C′ represents any divisor of R×C) of data in a matrix of R columns×C rows in row-major order and reading the data of the original data block in column-major order includes a memory configured to store R×C portions of data, a write address generator configured to generate write addresses based on a first incremental value, a read address generator configured to generate read addresses other than other than (n×R)+1th read addresses based on the first incremental value and to generate the (n×R)+1th read addresses based on a second incremental value, and a memory interface configured to successively read data from a read address and to successively write data of an input data block to a write address.

### CROSS-REFERENCE TO RELATED APPLICATIONS

This is a continuation of International Application No. PCT/JP2011/000091 filed on Jan. 12, 2011, which claims priority to Japanese Patent Application No. 2010-158054 filed on Jul. 12, 2010. The entire disclosures of these applications are incorporated by reference herein.

### BACKGROUND ART

The present disclosure relates to a data processing device, and particularly relates to a device and a method for de-interleaving an interleaved data block, and a data transmission system and a data transmission method for transmitting interleaved data and de-interleaving the received interleaved data.

Upon data transmission in, e.g., digital terrestrial broadcasting or wireless communication, a burst error may occur due to, e.g., pulse interference or fading. When the burst error occurs, error correction of received data in a receiver cannot be performed, resulting in, e.g., image degradation of broadcasting contents.

As a data transmission method effective for the burst error, an interleaving system has been employed. In the interleaving system, an interleaving device serving as a transmitter stores data of an original data block in a matrix in row-major order, and reads the data of the original data block in column-major order. In such a manner, the interleaving device generates interleaved data with the data of the original data block being rearranged. A de-interleaving device serving as a receiver receives the interleaved data block. In the de-interleaving device, data of the received data block is stored in a matrix in column-major order, and is read in row-major order. In such a manner, the original data block is restored with the data of the input data block being rearranged once again (see, e.g., Japanese Patent Publication No. 2004-147240). Since the interleaved original data block is transmitted as described above, the burst error can be replaced with a random error by de-interleaving even if the burst error occurs during the data transmission. Thus, the error correction of received data in the receiver can be performed.

The interleaving system is applicable to a data block having a variable data block length. If the data block length is variable, the number of rows varies when data of the data block is stored in a matrix in row-major order upon interleaving processing. The de-interleaving device does not use some of the rows of the matrix depending on the length of the input data block. That is, generation of write addresses for the unused rows is skipped, and therefore the input data block having the variable length is de-interleaved based on a principle which is basically the same as that used for a data block having a fixed length.

For de-interleaving of an input data block having a fixed length, every time data is read from a memory, received data may be written to the same address as that of the read data. Thus, writing of data of an input data block and reading of data of an input data block stored in the memory right before the writing can be performed by using a single memory. On the other hand, for de-interleaving of an input data block having a variable length, a data block from which data is read and a data block in which data is written may be different from each other in a block length. In particular, if the length of the data block in which data is written is longer, there is a possibility that data is overwritten to an address, data of which is not yet read. In order to avoid the data overwriting, two memories are alternately used such that data is written in one of the memories while data is read from the other memory. Alternatively, if a single memory is used to read and write data as in the de-interleaving of the input data block having the fixed length, it is necessary to provide a buffer configured to temporarily store data to be received within a period caused by skipping generation of write addresses for unused rows. However, in any of the foregoing cases, an additional memory unit such as the memory or the buffer is required, resulting in an increase in circuit area.

Therefore, there is a need for a de-interleaving device and a de-interleaving method for de-interleaving, without an additional memory unit, an input data block having a variable length by using a single memory. Moreover, there is a need for a data transmission system including the de-interleaving device and a data transmission method.

### SUMMARY

A de-interleaving device for de-interleaving an input data block interleaved by storing data of an original data block including R×C′ portions of data in a matrix of R columns×C rows in row-major order and reading the data of the original data block in column-major order to restore the original data block, C′ representing any divisor of R×C, includes a memory configured to store R×C portions of data; a write address generator configured to generate, starting from an initial value, a write address of the memory for each input data block based on a first incremental value provided as a difference between the initial value and a c+1th write address for a first-previous input data block stored in the memory, c representing the number of rows when data of the first-previous input data block is stored in the matrix in row-major order; a read address generator configured to generate, starting from the initial value, a read address of the memory other than a (n×R)+1th read address for each input data block based on the first incremental value, and to generate the (n×R)+1th read address based on a second incremental value provided as a difference between the initial value and a second write address for a first-previous input data block stored in the memory, n being an integer of 0 or more; and a memory interface configured to successively read data from the read address generated by the read address generator, and to successively write data of the input data block to the write address generated by the write address generator.

A de-interleaving method for de-interleaving an input data block to restore an original data block by storing, in a memory, the input data block interleaved by storing data of the original data block including R×C′ portions of data in a matrix of R columns×C rows in row-major order and reading the data of the original data block in column-major order, C′ representing any divisor of R×C, includes generating a first incremental value provided as a difference between first and c+1th write addresses for a first-previous input data block stored in the memory, c representing the number of rows when data of the first-previous input data block is stored in the matrix in row-major order; generating a second incremental value provided as a difference between first and second write addresses for a first-previous input data block stored in the memory; generating, starting from an initial value, a write address of the memory for each input data block based on the first incremental value; generating, starting from the initial value, a read address of the memory other than a (n×R)+1th read address for each input data block based on the first incremental value, and generating the (n×R)+1th read address based on the second incremental value, n being an integer of 0 or more; and successively reading data from the generated read address, and successively writing data of an input data block to the generated write address.

According to the de-interleaving device or the de-interleaving method, write addresses are generated based on the first incremental value regardless of the length of an input data block. On the other hand, read addresses other than (n×R)+1th read addresses are generated based on the first incremental value, and the (n×R)+1th read addresses are generated based on the second incremental value. As long as the number C′ of rows when data of an input data block is stored in a matrix of R columns×C rows in row-major order is one of divisors of R×C, a read address leads a write address at all times even if a data block for reading and a data block for writing are different from each other in a block length. That is, it is ensured that, after a read address is generated for any address of the memory and data is read, a write address having the same value is generated. Thus, generation of a write address is not necessarily skipped, and a buffer configured to temporarily store received data is not necessary.

A data transmission system or a data transmission method includes an interleaving device or an interleaving step for generating and transmitting a data block interleaved by storing data of an original data block including R×C′ portions of data in a matrix of R columns×C rows in row-major order and reading the data of the original data block in column-major order, C′ representing any divisor of R×C; and the foregoing de-interleaving device configured to receive the interleaved data block and to de-interleave the received data block to restore the original data block, or a step for de-interleaving, according to the foregoing de-interleaving method, the received data block to restore the original data block.

### BRIEF DESCRIPTION OF THE DRAWINGS

FIG. 1 is a configuration diagram of a de-interleaving device of an embodiment of the present disclosure.

FIG. 2 is a configuration diagram of a de-interleaving device of a variation.

FIG. 3 is a schematic diagram illustrating a relationship between an original data block and an interleaved data block.

FIG. 4 is a schematic diagram illustrating generation of write addresses for storing a first input data block.

FIG. 5 is a schematic diagram illustrating generation of read addresses for de-interleaving the first input data block and generation of write addresses for storing a second input data block.

FIG. 6 is a schematic diagram illustrating generation of read addresses for de-interleaving the second input data block and generation of write addresses for storing a third input data block.

FIG. 7 is a schematic diagram illustrating generation of read addresses for de-interleaving the third input data block.

FIG. 8 is a configuration diagram of a data transmission system of the embodiment of the present disclosure.

### DETAILED DESCRIPTION

Embodiments are described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventors provide the following description and the attached drawings to enable those skilled in the art to fully understand the present disclosure. Thus, the description and the drawings are not intended to limit the scope of the subject matter defined in the claims.

(Embodiment of De-Interleaving Device)

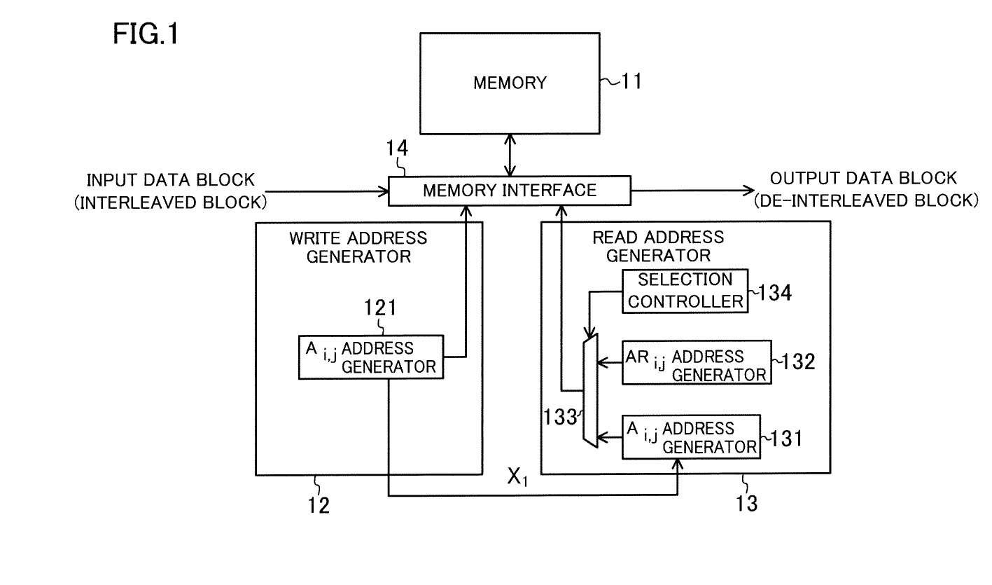

FIG. 1 illustrates a configuration of a de-interleaving device of an embodiment of the present disclosure. The de-interleaving device of the present embodiment is configured to de-interleave an interleaved input data block (i.e., an interleaved block) to generate an output data block (i.e., a de-interleaved block). For the sake of description, it is assumed that the input data block is a data block interleaved in such a manner that data stored in a matrix of R columns and C rows in row-major order is read in column-major order in an interleaving device which is not shown in the figure. In addition, it is assumed that the input data block is a variable-length data block satisfying a condition of Block Length=R×C′ (where C′ represents any divisor of R×C).

In the de-interleaving device of the present embodiment, a memory 11 is configured to store M portions (where M=R×C) of data. For the sake of simplicity, it is assumed that a memory address is specified by each of integers of “0” to “M−1.” A memory interface 14 successively reads data from read addresses of the memory 11 generated by a read address generator 13. Meanwhile, the memory interface 14 successively writes data of the input data block to write addresses of the memory 11 generated by a write address generator 12.

For each input data block, the write address generator 12 generates, starting from an initial value (e.g., “0”), write addresses of the memory 11 based on an incremental value Xⱼ which is provided as a difference between the initial value and a c+1th (where c is the number of rows when data of a first-previous input data block stored in the memory 11 is stored in a matrix of R columns×C rows in row-major order) write address of the first-previous input data block. Specifically, the write address generator 12 includes an address generator 121 configured to generate an address A_{i, j}, and supplies, as a write address, the address A_{i, j} generated by the address generator 121 to the memory interface 14.

The address generator 121 generates the address A_{i, j} according to a formula described below. In the formula, i represents an identification number of data of each input data block, and j represents an identification number of an input data block itself. In addition, cⱼ₋₁ represents the number of rows when data of a first-previous input data block is stored in a matrix of R columns×C rows in row-major order, and can be any divisor of R×C under the condition of Block Length=R×C′. Note that i and j are generated by a counter which is not shown in the figure. For the sake of simplicity, it is assumed that each of i and j is an integer increasing from “0” by “1” in the order of entering the de-interleaving device.

$$[ Formula 1 ] \\ \begin{matrix}{A}_{0 j} = 0 \\ \begin{matrix}{A}_{ij} = ( {A}_{i - 1 j} + {X}_{j} ) & when {A}_{i - 1 j} < M - {X}_{j} \\ {A}_{ij} = ( {A}_{i - 1 j} - ( M - {X}_{j} - 1 ) ) & when {A}_{i - 1 j} \geq M - {X}_{j}\end{matrix} \} for i > 0\end{matrix} ] \\ where \text{:} \\ \begin{matrix}{X}_{0} = 1 & \\ {X}_{j} = ( {X}_{j - 1} \cdot {c}_{j - 1} ) mod M + ( {X}_{j - 1} \cdot {c}_{j - 1} ) div M & for j > 0\end{matrix} ]$$

For each input data block, the read address generator 13 generates, starting from an initial value (e.g., “0”), read addresses of the memory 11 other than (n×R)+1th (where n is an integer of 0 or more) read addresses based on the incremental value Xⱼ. The read address generator 13 generates the (n×R)+1th read addresses based on an incremental value Yⱼ which is provided as a difference between the initial value and a second write address of a first-previous input data block stored in the memory 11. Specifically, the read address generator 13 includes an address generator 131 configured to generate an address A_{i, j} based on the incremental value Xⱼ, an address generator 132 configured to generate an address AR_{i, j} based on the incremental value Yⱼ, a multiplexer 133 configured to selectively supply either one of the read addresses generated by the foregoing address generators to the memory interface 14, and a selection controller 134 configured to control the selection performed by the multiplexer 133.

The address generator 131 generates the address A_{i, j} according to a formula described below. The formula is basically the same as that used for the address generator 121, except that not “1” but X₁ generated by the address generator 121 is used as X₀ and the address A_{i, j} is renewed to the addresses AR_{i, j} when (i mod R)=0.

$$[ Formula 2 ] \\ \begin{matrix}{A}_{0 j} = 0 \\ \begin{matrix}{A}_{ij} = {AR}_{ij} & when ( i mod R ) = 0 \\ {A}_{ij} = ( {A}_{i - 1 j} + {X}_{j} ) & when {A}_{i - 1 j} < M - {X}_{j} \\ {A}_{ij} = ( {A}_{i - 1 j} - ( M - {X}_{j} - 1 ) ) & when {A}_{i - 1 j} \geq M - {X}_{j}\end{matrix} \} for i > 0\end{matrix} ] \\ where \text{:} \\ \begin{matrix}{X}_{0} = {X}_{1} for Write Address & \\ {X}_{j} = ( {X}_{j - 1} \cdot {c}_{j} ) mod M + ( {X}_{j - 1} \cdot {c}_{j} ) div M & for j > 0\end{matrix} ]$$

The address generator 132 generates the addresses AR_{i, j} according to a formula described below.

$$[ Formula 3 ] \\ \begin{matrix}{AR}_{0 j} = 0 \\ \begin{matrix}{AR}_{ij} = ( {AR}_{i - Rj} + {Y}_{j} ) & when {AR}_{i - Rj} < M - {Y}_{j} \\ {AR}_{ij} = ( {AR}_{i - Rj} - ( M - {Y}_{j} - 1 ) ) & when {AR}_{i - Rj} \geq M - {Y}_{j}\end{matrix} \} for i > R\end{matrix} ] \\ where \text{:} \\ \begin{matrix}{Y}_{0} = 1 & \\ {Y}_{j} = ( {Y}_{j - 1} \cdot {c}_{j} ) mod M + ( {Y}_{j - 1} \cdot {c}_{j} ) div M & for j > 0\end{matrix} ]$$

The selection controller 134 controls the selection performed by the multiplexer 133. Specifically, the selection controller 134 causes the multiplexer 133 to select the address generator 131 when (i mod R)≠0 and to select the address generator 132 when (i mod R)=0.

<Variation>

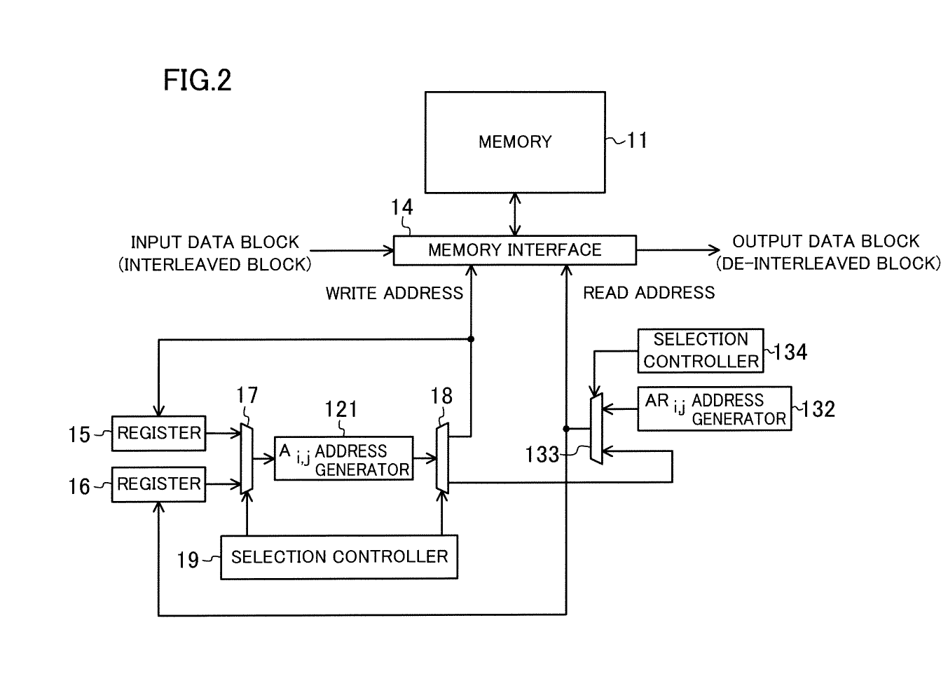

Since address generation criterions for the address generator 121 and the address generator 131 are substantially identical to each other, the write address generator 12 and the read address generator 13 may time-share a single address generator. For example, the address generator 131 may be omitted, and read addresses may be generated in the address generator 121. FIG. 2 illustrates a configuration of a de-interleaving device of such a variation. In order to allow generation of both of read and write addresses by the address generator 121, the de-interleaving device of the present variation includes a register 15 configured to store a first-previous write address, a register 16 configured to store a first-previous read address, a multiplexer 17 configured to selectively supply either one of the addresses stored in the registers to the address generator 121, a demultiplexer 18 configured to selectively supply, as either one of a read address or a write address, an address generated by the address generator 121 to the memory interface 14, and a selection controller 19 configured to control the selection performed by the multiplexer 17 and the demultiplexer 18.

An operation of the selection controller 19 is as follows. In the case of write address generation, the selection controller 19 causes the multiplexer 17 to select the register 15, and causes the demultiplexer 18 to output, as a write address, an address generated by the address generator 121. On the other hand, in the case of read address generation, the selection controller 19 causes the multiplexer 17 to select the register 16, and causes the demultiplexer 18 to output, as a read address, an address generated by the address generator 121.

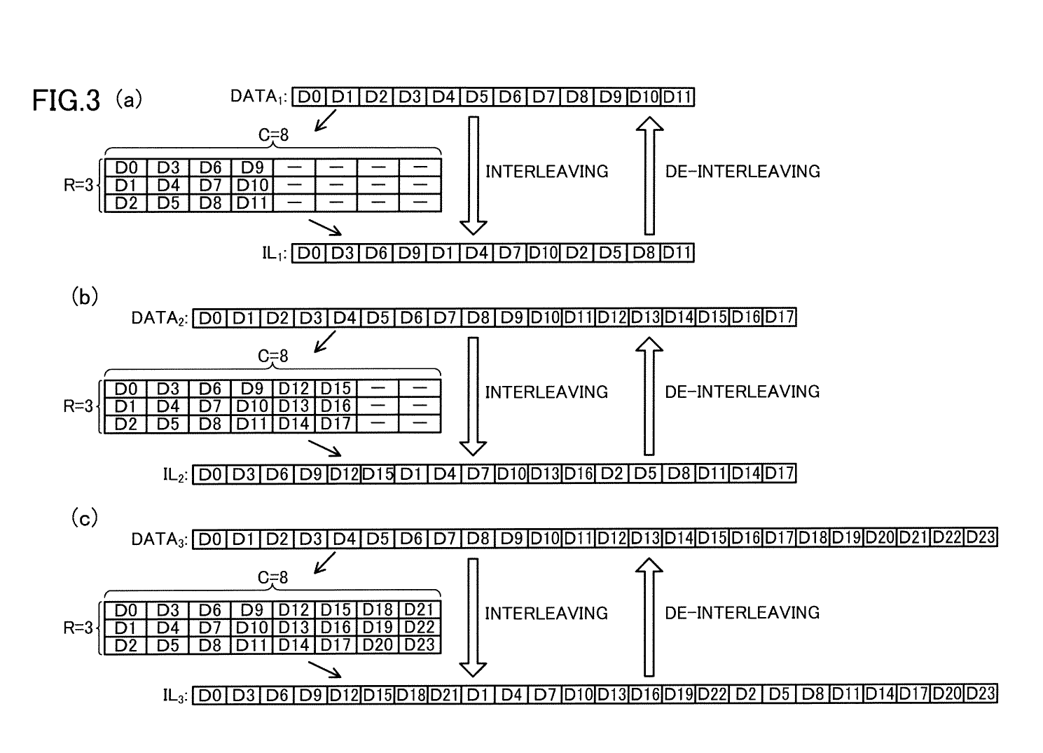

Next, de-interleaving processing by the de-interleaving device of the present embodiment will be described with a specific example. Referring to FIG. 3, data of an original data block is stored in a matrix of three columns×eight rows in row-major order, and is read in column-major order. In such a manner, an interleaved block is generated. The de-interleaving device de-interleaves such an interleaved block to restore the original data block. Each of a first original data block DATA₁ and an interleaved block IL₁ includes 12 data portions (=three columns×four rows), i.e., data D0-D11. Each of a second original data block DATA₂ and an interleaved block IL₂ includes 18 data portions (=three columns×six rows), i.e., data D0-D17. Each of a third original data block DATA₃ and an interleaved block IL₃ includes 24 data portions (=three columns×eight rows), i.e., data D0-D23.

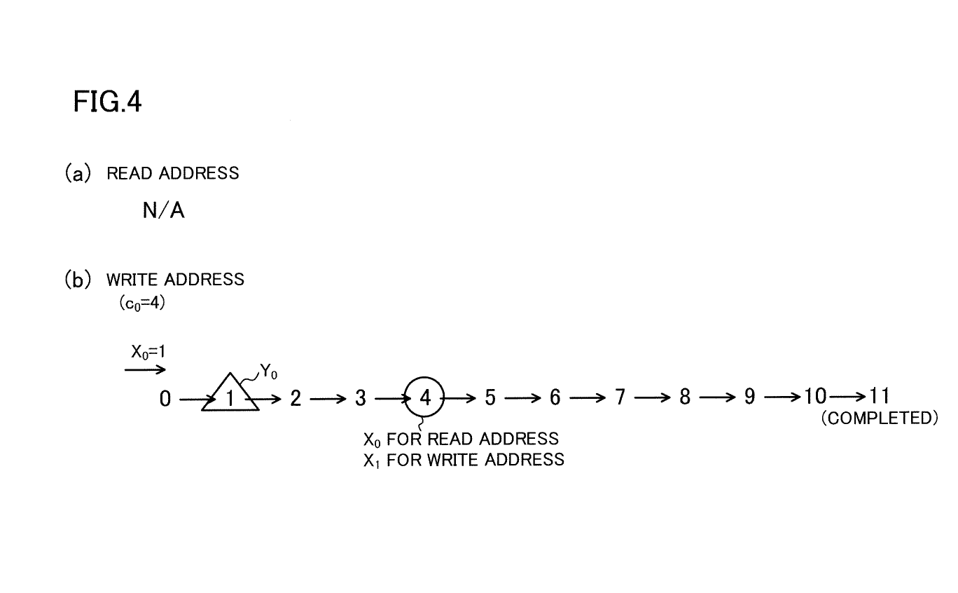

The de-interleaving device generates write addresses in the order indicated by solid arrows illustrated in FIG. 4, and stores the interleaved block IL₁ in the memory 11. That is, the write address is, starting from an initial value of “0,” increased by X₀=1 upon the storage of the interleaved block IL₁. Since there is no data to be read at this point, read addresses are not applicable (N/A).

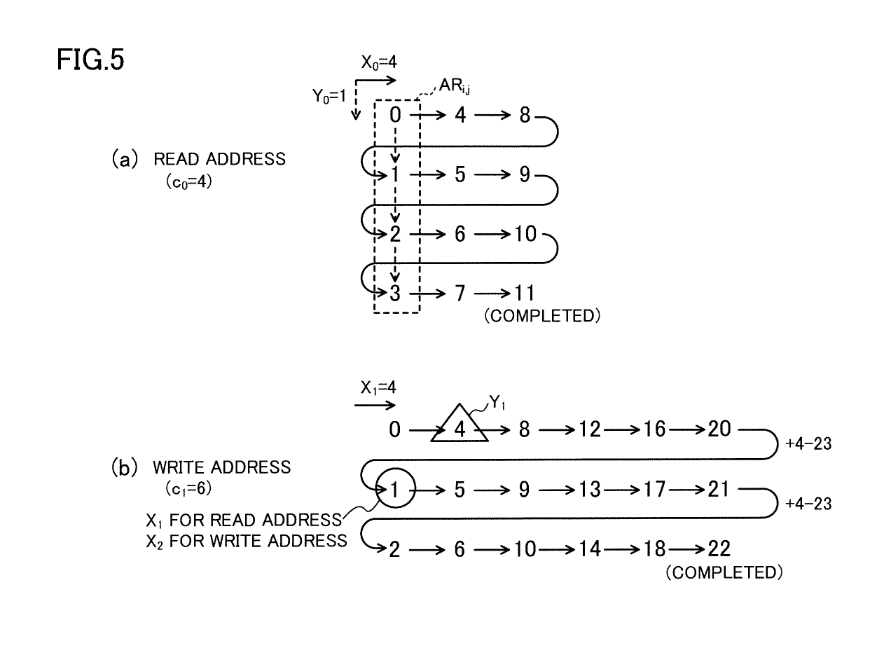

When the storage of the interleaved block IL₁ is completed, the de-interleaving device generates read addresses and write addresses in the order indicated by solid arrows illustrated in FIG. 5. Then, the de-interleaving device reads the interleaved block IL₁ from the memory 11 to de-interleave the interleaved block IL₁ while storing the interleaved block IL₂ in the memory 11. An incremental value X₀ for the read address generation and an incremental value X₁ for the write address generation are provided as a difference between the initial value and the fifth write address for the interleaved block IL₁, and an incremental value Y₀ for the read address generation is provided as a difference between the initial value and the second write address for the interleaved block IL₁. Since the initial value is “0,” the fifth write address of “4” for the interleaved block IL₁ is, without change, regarded as the incremental values X₀ and X₁, and the second write address of “1” for the interleaved block IL₁ is, without change, regarded as the incremental value Y₀ (see FIG. 5).

It should be noted that, if the write address is increased from the initial value of “0” by X₀=4 (if the write address reaches more than “24” by adding “4,” “23” is subtracted from the write address), the read address is renewed to the addresses AR_{i, j} every time three read addresses are generated. Thus, even if a data block for reading and a data block for writing are different from each other in a block length, a read address leads a write address at all times. Consequently, data is not overwritten to an address, data of which is not yet read, and a disadvantage relating to the overwriting of data is not caused. For example, when write addresses of “1,” “5,” and “9” are generated, data is already read from each of such addresses.

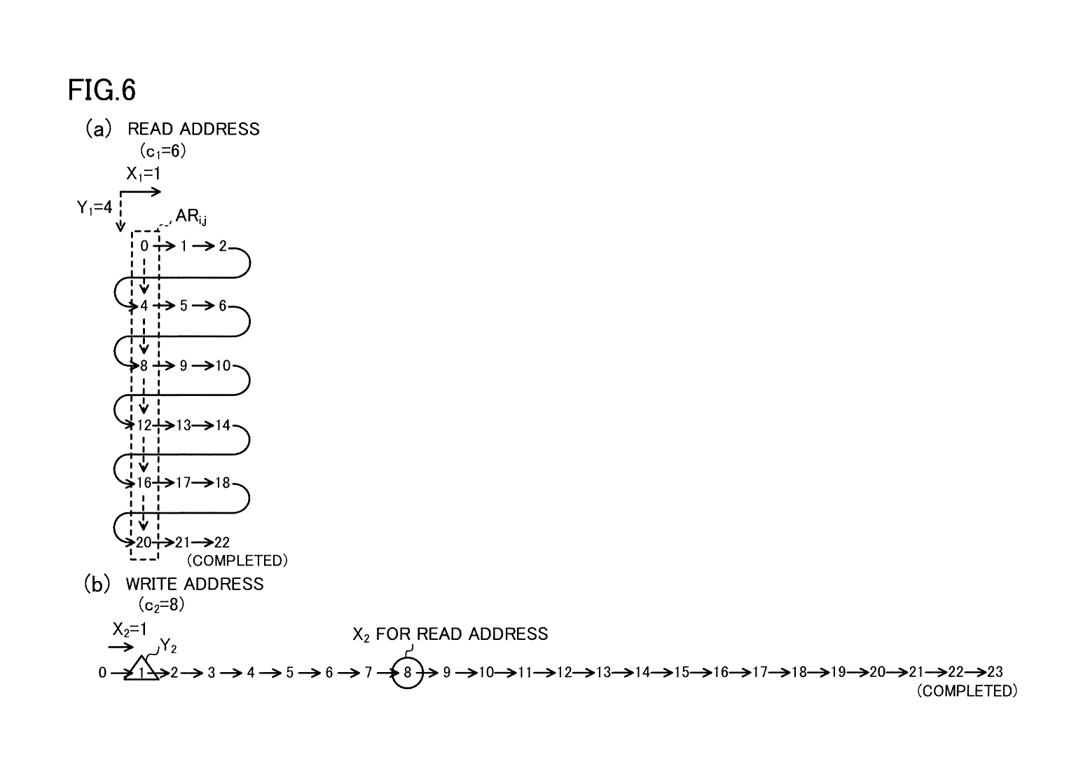

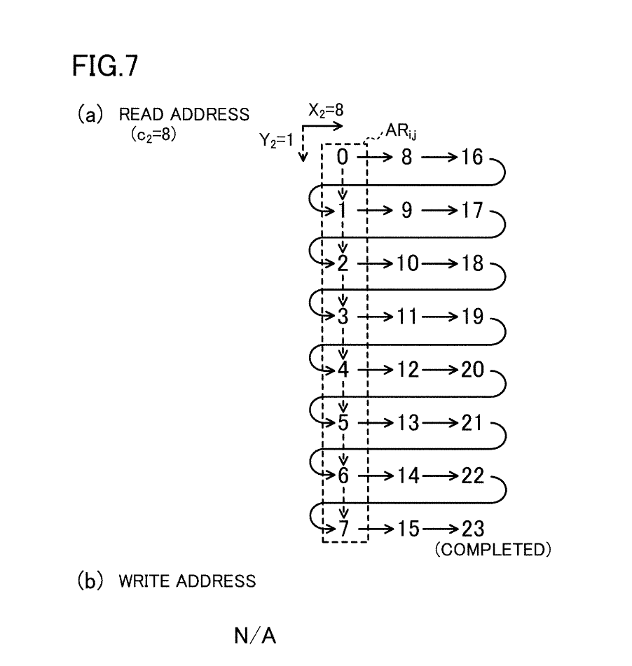

Similarly, when the de-interleaving of the interleaved block IL₁ is completed, the de-interleaving device generates read addresses and write addresses in the order indicated by solid arrows illustrated in FIG. 6. Then, the de-interleaving device reads the interleaved block IL₂ from the memory 11 to de-interleave the interleaved block IL₂ while storing the interleaved block IL₃ in the memory 11. The seventh write address of “1” for the interleaved block IL₂ is, without change, regarded as an incremental value X₁ for the read address generation and an incremental value X₂ for the write address generation, and the second write address of “4” for the interleaved block IL₂ is, without change, regarded as an incremental value Y₁ for the read address generation (see FIG. 5). When the de-interleaving of the interleaved block IL₂ is completed, the de-interleaving device generates read addresses in the order indicated by solid arrows illustrated in FIG. 7, and reads the interleaved block IL₃ from the memory 11 to de-interleave the interleaved block IL₃. The ninth write address of “8” for the interleaved block IL₃ is regarded as an incremental value X₂ for the read address generation, and the second write address of “1” for the interleaved block IL₃ is regarded as an incremental value Y₂ for the read address generation (see FIG. 6).

According to the present embodiment, an input data block having a variable length can be, without an additional memory unit such as a buffer, de-interleaved by using a single memory. Thus, a circuit area of the de-interleaving device can be decreased.

The write address generator 12 and the read address generator 13 can be implemented as software executed by a central processing unit (CPU) which is not shown in the figure. The write address generator 12 and the read address generator 13 can be also implemented as a lookup table from which pre-calculated addresses are, without calculating write addresses and read addresses point by point, read according to the length of an input data block and an identification number of data.

(Embodiment of Data Transmission System)

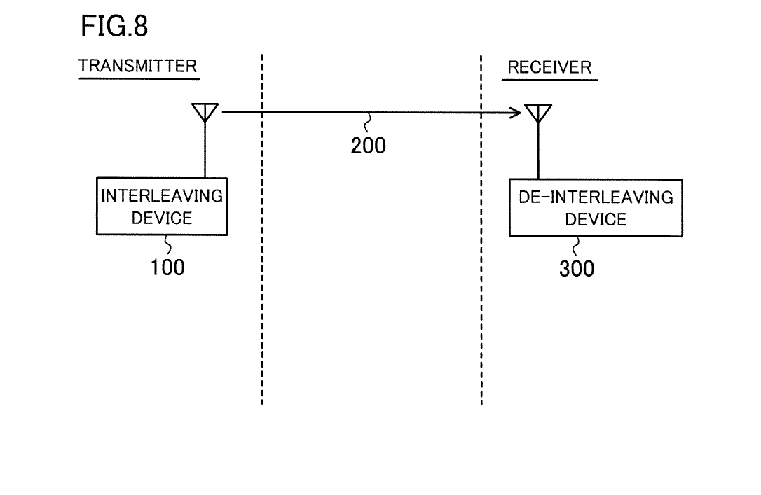

FIG. 8 illustrates a configuration of a data transmission system of the embodiment of the present disclosure. The data transmission system is, e.g., a digital terrestrial broadcasting system. An interleaving device 100 placed in, e.g., a broadcasting station as a transmitter stores data of a data block of broadcasting contents in a not-shown matrix of R columns×C rows in row-major order, and reads the data in column-major order. In such a manner, the original data block is interleaved. Note that the original data block includes R×C′ portions (C′ is any divisor of R×C) of data. The interleaved data block is broadcasted in the form of a terrestrial digital wave 200.

The foregoing de-interleaving device 300 is placed in, e.g., each house to be a receiver. The de-interleaving device 300 is mounted in, e.g., a terrestrial digital wave tuner. The de-interleaving device 300 obtains the interleaved block from the received terrestrial digital wave 200, and de-interleaves the interleaved block to restore the original data block. Then, after, e.g., error correction is performed for the restored original data block, the broadcasting contents are reproduced.

Various embodiments have been described above as example techniques of the present disclosure, in which the attached drawings and the detailed description are provided.

As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

What is claimed is:

1. A de-interleaving device for de-interleaving an input data block interleaved by storing data of an original data block including R×C′ portions of data in a matrix of R columns×C rows in row-major order and reading the data of the original data block in column-major order to restore the original data block, C′ representing any divisor of R×C, the de-interleaving device comprising:
a memory configured to store R×C portions of data;
a write address generator configured to generate, starting from an initial value, a write address of the memory for each input data block based on a first incremental value provided as a difference between the initial value and a c+1th write address for a first-previous input data block stored in the memory, c representing the number of rows when data of the first-previous input data block is stored in the matrix in row-major order;
a read address generator configured to generate, starting from the initial value, a read address of the memory other than a (n×R)+1th read address for each input data block based on the first incremental value, and to generate the (n×R)+1th read address based on a second incremental value provided as a difference between the initial value and a second write address for a first-previous input data block stored in the memory, n being an integer of 0 or more; and
a memory interface configured to successively read data from the read address generated by the read address generator, and to successively write data of the input data block to the write address generated by the write address generator.

2. The de-interleaving device of claim 1, wherein
the read address generator includes
a first address generator configured to generate a read address based on a value obtained by adding the first incremental value to a first-previous read address,
a second address generator configured to generate a read address based on a value obtained by adding the second incremental value to a Rth-previous read address,
a multiplexer configured to selectively supply one of the read addresses generated by the first and second address generators to the memory interface, and
a selection controller configured to control selection performed by the multiplexer.

3. The de-interleaving device of claim 1, further comprising:
a first register configured to store a first-previous write address;
a second register configured to store a first-previous read address;
an address generator time-shared by the write address generator and the read address generator and configured to generate an address based on a value obtained by adding the first incremental value to a given address;
a multiplexer configured to selectively supply one of addresses stored in the first and second registers to the address generator;
a demultiplexer configured to selectively supply, as one of a read address or a write address, an address generated by the address generator to the memory interface, and
a selection controller configured to control selection performed by the multiplexer and the demultiplexer.

4. A de-interleaving method for de-interleaving an input data block to restore an original data block by storing, in a memory, the input data block interleaved by storing data of the original data block including R×C′ portions of data in a matrix of R columns×C rows in row-major order and reading the data of the original data block in column-major order, C′ representing any divisor of R×C, the method comprising:
generating a first incremental value provided as a difference between first and c+1th write addresses for a first-previous input data block stored in the memory, c representing the number of rows when data of the first-previous input data block is stored in the matrix in row-major order;
generating a second incremental value provided as a difference between first and second write addresses for a first-previous input data block stored in the memory;
generating, starting from an initial value, a write address of the memory for each input data block based on the first incremental value;
generating, starting from the initial value, a read address of the memory other than a (n×R)+1th read address for each input data block based on the first incremental value, and generating the (n×R)+1th read address based on the second incremental value, n being an integer of 0 or more; and
successively reading data from the generated read address, and successively writing data of an input data block to the generated write address.

5. A data transmission system comprising:
an interleaving device configured to generate and transmit a data block interleaved by storing data of an original data block including R×C′ portions of data in a matrix of R columns×C rows in row-major order and reading the data of the original data block in column-major order, C′ representing any divisor of R×C; and
the de-interleaving device of claim 1 configured to receive the interleaved data block and to de-interleave the received data block to restore the original data block.

6. A data transmission method, comprising:
generating and transmitting a data block interleaved by storing data of an original data block including R×C′ portions of data in a matrix of R columns×C rows in row-major order and reading the data of the original data block in column-major order, C′ representing any divisor of R×C; and
receiving the interleaved data block and de-interleaving, according to the method of claim 4, the received data block to restore the original data block.
